(19) United States
(12) Patent Application Publication
(10) Pub. No.: US 2026/0009462 A1
(43) Pub. Date: Jan. 8, 2026

(54) LUBRICANT SUPPLY SYSTEM

(71) Applicant: HYUNDAI MOBIS CO., LTD., Seoul (KR)

(72) Inventors: Dae Wook KIM, Yongin-si (KR); Sang Woo KIM, Yongin-si (KR)

(73) Assignee: HYUNDAI MOBIS CO., LTD., Seoul (KR)

(21) Appl. No.: 19/202,380

(22) Filed: May 8, 2025

(30) Foreign Application Priority Data
Jul. 3, 2024 (KR) 10-2024-0087607

(51) Int. Cl. F16H 57/04; F16H 57/02; F16H 57/08

(52) U.S. Cl. CPC F16H 57/0471; F16H 57/0423; F16H 57/0427; F16H 57/043; F16H 57/0436; F16H 57/045; F16H 57/046; F16H 57/0476; F16H 57/0486; F16H 57/082; F16H 2057/02034; F16H 2057/085

(57) ABSTRACT

The present disclosure relates to a lubricant supply system, and more specifically, to a lubricant supply system applied to a motor for a vehicle. According to the lubricant supply system of the present disclosure, by including the flow path along which lubricant is supplied to the shaft, the oil spreader coupled to the shaft, and the carrier that receives oil dispersed from the oil spreader and inserting the pin that stores and supplies lubricant into the carrier, it is possible to minimize forced lubrication compared to conventional ones and allow oil to be smoothly supplied to a needle bearing and a carrier bearing even during high-speed rotation using a centrifugal force and wind power generated naturally by an on-axis rotors.

### CROSS REFERENCE TO RELATED APPLICATION

The present application claims priority to Korean Patent Application No. 10-2024-0087607, filed Jul. 3, 2024, the entire contents of which is incorporated herein for all purposes by this reference.

### BACKGROUND OF THE DISCLOSURE

### Field of the Disclosure

The present disclosure relates to a lubricant supply system, and more specifically, to a lubricant supply system applied to a motor for a vehicle.

### Description of the Related Art

Unlike conventional off-axis rotors, a reducer of a motor with an on-axis rotor in which a drive shaft is inserted into the center of a rotor shaft cannot form an oil flow path at the center of the rotor, and thus needs to supply oil by only rotation (churning), and it is difficult to lubricate each bearing included in the reducer by only churning. Accordingly, the on-axis rotor needs to form a separate oil lubrication path in a different form from conventional ones to forcibly supply oil to components of the reducer and lubricate the components. Accordingly, there are problems that the required specifications of a pump supplying oil are higher and the size is larger.

More specifically, in the case of conventional churning methods, since lubricant stays at only an edge rather than internal parts of the motor and the reducer due to a centrifugal force and wind power caused by a rapidly rotating planet gear, there is a problem that the lubricant is not supplied to a bearing positioned at a central portion. In addition, even when a flow path for forcibly supplying lubricant is formed in the rotor of the motor, there is a problem in that the lubricant is only supplied to some parts and the oil is not supplied to a needle bearing disposed therein.

### DOCUMENT OF RELATED ART

[Patent Document 1] Korean Laid-Open Patent No. 10-2024-0087229 tilted “reducer for electric vehicle” published on Dec. 12, 2022

### SUMMARY OF THE DISCLOSURE

The present disclosure has been made in efforts to solve the above problems and is directed to providing a lubricant supply system which includes a flow path along which lubricant is supplied to a shaft, an oil spreader coupled to the shaft, and a carrier that receives oil dispersed from the oil spreader and in which a pin that stores and supplies lubricant is inserted into the carrier, thereby minimizing forced lubrication compared to conventional ones and allowing oil to be smoothly supplied to a needle bearing and a carrier bearing even during high-speed rotation using a centrifugal force and wind power generated naturally by an on-axis rotors.

To solve the above problems, a lubricant supply system mounted on a motor according to one embodiment of the present disclosure includes a carrier which has an insertion hole formed at a central portion thereof and in which a carrier bearing of the motor is inserted into the insertion hole, an oil flow path inserted into a housing of the motor, and an oil dispersion part that is coupled to the carrier and a shaft of the motor and disperses lubricant, wherein the oil flow path is formed to have at least one outlet facing the shaft side so that lubricant is sprayed to the shaft of the motor.

In addition, the oil flow path includes a main flow path connected to a pump that supplies lubricant and formed to extend in a radial direction of the motor, and a forced lubrication reduction flow path formed to extend from the main flow path toward the shaft of the motor.

In addition, the oil dispersion part includes an oil spreader that is inserted between the insertion hole and the shaft of the motor and disperses lubricant received from the forced lubrication reduction flow path in the radial direction of the motor.

In addition, the oil spreader includes a fixed part in which a coupling hole inserted into the shaft of the motor is formed, and a spray part that is formed to extend in the radial direction from the fixed part and stores and sprays lubricant.

In addition, the spray part includes a first extension that has one end connected to an end of the fixed part and is formed to extend in the radial direction of the motor, a second extension formed to extend from the first extension in the axial direction of the motor, and a third extension formed to extend from the second extension in the radial direction of the motor.

In addition, the second extension has two or more spray holes formed in a circumferential direction.

In addition, the oil dispersion part includes a pin which is inserted into the carrier in an axial direction of the motor and in which a flow path in which lubricant is stored is formed to extend in the axial direction of the motor.

In addition, the pin includes a first flow path in which lubricant is stored and which is formed to extend in the axial direction of the motor, and a second flow path formed in a direction perpendicular to the first flow path and formed to pass through the pin.

In addition, the first flow path includes an open groove of which one end that comes into contact with one surface of the carrier is open and the other end is closed and which has a larger flow cross-sectional area than the first flow path at one end thereof.

In addition, the carrier includes a transfer flow path of which one end communicates with the first flow path and which is formed to extend in the radial direction of the motor.

### BRIEF DESCRIPTION OF THE DRAWINGS

FIG. 1 is a partial cross-sectional view illustrating an internal structure of a motor to which a lubricant supply system of the present disclosure is applied.

FIG. 2 is a partial cross-sectional view illustrating an oil supply flow path of the present disclosure.

FIG. 3 is a partial cross-sectional view illustrating an oil dispersion part of the present disclosure.

FIG. 4 is a perspective view illustrating an oil spreader of the present disclosure.

FIG. 5 is a perspective view illustrating a pin of the present disclosure.

FIG. 6 is a partial cross-sectional view illustrating a transfer flow path of the present disclosure.

### DETAILED DESCRIPTION OF THE DISCLOSURE

Hereinafter, the technical spirit of the present disclosure will be described in more detail with reference to the accompanying drawings. Prior to this, terms or words used in this specification and claims should not be interpreted as limited to their usual or dictionary meanings and should be interpreted as meanings and concepts that conform to the technical idea of the present disclosure based on the principle that the inventor can appropriately define the concepts of the terms in order to describe his or her own disclosure in the best way.

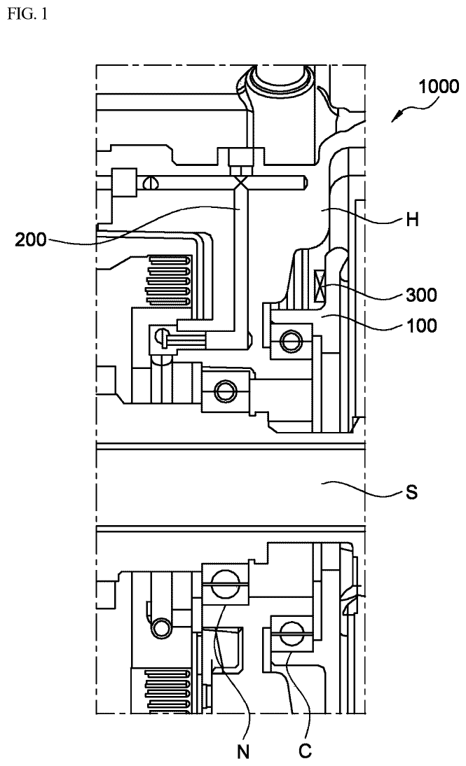

Hereinafter, an internal structure of a motor to which a lubricant supply system 1000 of the present disclosure is applied will be briefly described with reference to FIG. 1.

The lubricant supply system 1000 of the present disclosure may be mounted on a motor to supply lubricant to parts of a reducer and may include a carrier 100 in which an insertion hole is formed at a central portion and a carrier bearing, which is one of the parts of the motor, is inserted into the insertion hole, and an oil flow path 200 inserted into a housing of the motor. Lubricant may be supplied from a pump to the inside and outside of the housing the motor through the oil flow path 200, and the reducer of the motor may be forcibly lubricated through the oil flow path 200. The oil flow path 200 may be formed to have at least one outlet facing the shaft side so that lubricant is sprayed onto the shaft of the motor.

In addition, the lubricant supply system 1000 of the present disclosure may include an oil dispersion part 300 that is coupled to the carrier 100 and the shaft of the motor and disperses lubricant. The oil dispersion part 300 may receive some lubricant from the oil flow path 200 using a centrifugal force and wind power and disperse the lubricant to internal parts of the reducer and a plurality of bearings (a needle bearing and the like) positioned at a central portion of the motor. The oil dispersion part 300 may receive the lubricant dispersed toward the shaft of the motor through the oil flow path 200 and transfer the lubricant to parts positioned at the central portion side.

In this way, by dispersing some oil for forced lubrication toward the shaft of the motor, the lubricant can be evenly dispersed to the parts of the reducer, such as the bearing positioned at the central portion side, through a centrifugal force and wind power. In addition, it is possible to minimize a flow volume required for forced lubrication and smoothly lubricate each part of the reducer even when the required specifications of the oil pump are lower.

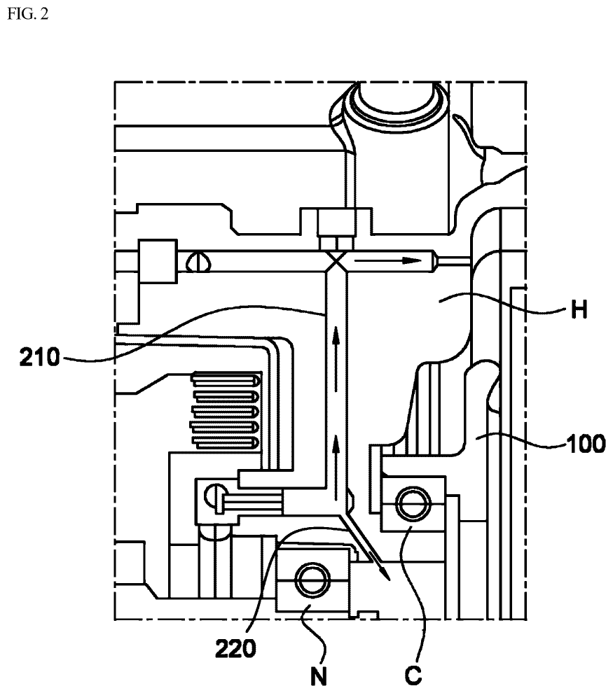

Hereinafter, the oil flow path 200 of the present disclosure will be described in more detail with reference to FIG. 2.

More specifically, as illustrated in FIG. 2, the oil flow path 200 may include a main flow path 210 and a forced lubrication reduction flow path 220. More specifically, the main flow path 210 may be connected to the pump for supplying lubricant, formed to extend in a radial direction of the motor, and may have at least one outlet through which the lubricant is sprayed toward an edge of the motor. The lubricant may be forcibly injected through the main flow path 210 so that each part of the reducer may be forcibly lubricated.

In addition, the forced lubrication reduction flow path 220 may be formed to extend from the main flow path 210 toward the shaft of the motor. The forced lubrication reduction flow path 220 may be formed in a straight line, and an end, that is, an outlet, may be formed to face the shaft of the motor. By including the forced lubrication reduction flow path 220, some lubricant may be transferred toward the shaft of the motor, that is, the central portion of the motor, and the lubricant can be more efficiently transferred to the parts positioned at the central portion side by the oil dispersion part 300. Accordingly, even when the pump for supplying lubricant does not supply oil with a high flow volume, the lubricant may be transferred to all parts.

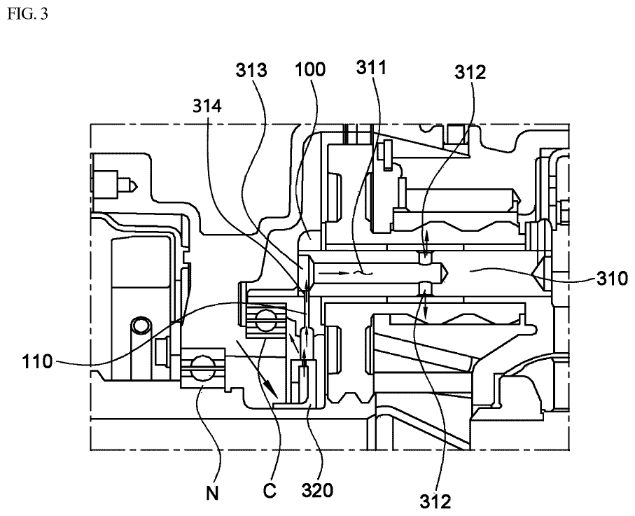

Hereinafter, the oil dispersion part 300 of the present disclosure will be described in more detail with reference to FIGS. 3 to 6.

As illustrated in FIG. 3, the oil dispersion part 300 may be applied to the carrier 100 to disperse lubricant. More specifically, the oil dispersion part 300 may include an oil spreader 320 and a pin 310. The oil spreader 320 is a part that is inserted between the shaft of the motor and the insertion hole of the carrier 100 and may disperse the lubricant received from the oil flow path 200 in a radial direction to disperse the lubricant toward the pin 310 or the carrier 100 and the needle bearing. The pin 310 may be inserted into the carrier 100 in an axial direction of the motor and may have a flow path in which lubricant is stored and which is formed to extend in the axial direction of the motor.

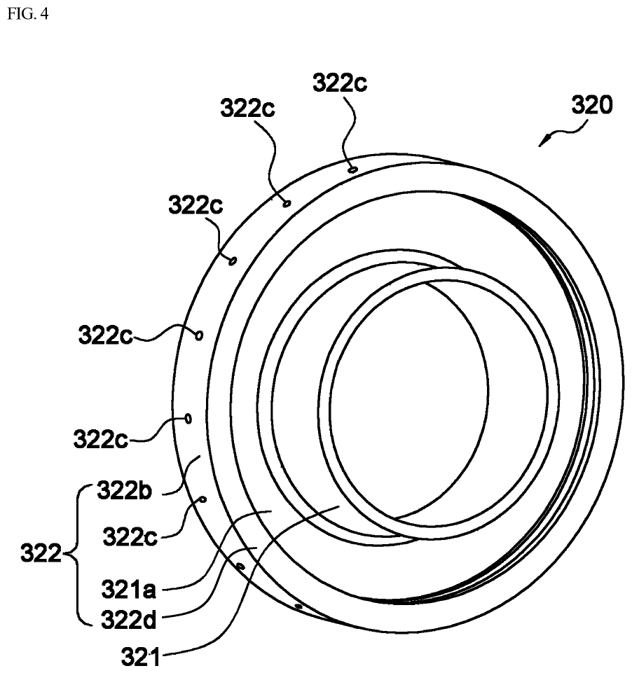

In addition, as illustrated in FIG. 4, the oil spreader 320 may include a fixed part 321 in which a coupling hole inserted into the shaft of the motor is formed, and a spray part 322 that is formed to extend from the fixed part 321 in the radial direction of the motor and stores and sprays lubricant. In addition, the spray part 322 may include a first extension 322a that has one end connected to an end of the fixed part 321 and is formed to extend in the radial direction of the motor, and a second extension 322b formed to extend from the first extension 322a in the axial direction of the motor.

In one embodiment, the oil spreader 320 may further include a third extension 322d formed to extend from the second extension 322b in the radial direction of the motor. By including the third extension 322d, it is possible to reinforce the strength of the second extension 322b that the oil collides therewith even when a flow rate of the lubricant is fast during high-speed rotation. In addition, by adjusting an extension length of the third extension 322d, an angle at which lubricant is dispersed between the third extension 322d and the fixed part 321 may be adjusted. The lubricant dispersed between the third extension 322d and the fixed part 321 may be dispersed toward the needle bearing or the carrier bearing.

The second extension 322b may have two or more spray holes 322c formed in a circumferential direction and disperse lubricant radially through the spray holes 322c. Basically, the spray holes 322c may be formed to be spaced regular intervals from each other, but to disperse lubricant biasedly toward a specific component, the spray holes 322c may be formed so that lubricant is collected at a side to which the lubricant wants to be biased. Alternatively, a larger diameter of the spray holes 322c at the side to which the lubricant wants to be biased may be formed. Alternatively, the spray holes 322c may be formed correspondingly at the side facing a transfer flow path 110 to be described below.

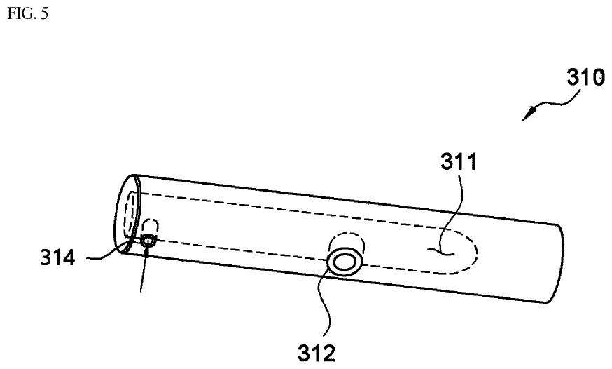

More specifically, as illustrated in FIG. 5, the pin 310 may include a first flow path 311 in which lubricant is stored and which is formed to extend in the axial direction of the motor, and a second flow path 312 formed in a direction perpendicular to the first flow path 311 and formed to pass through the pin 310. The second flow path 312 may be formed in the direction perpendicular to the first flow path 311, and the second flow path 312 may be formed to pass through the pin 310 in the radial direction of the motor. The second flow path 312 may be formed to pass through the entire pin 310 or formed to allow an internal space of the first flow path 311 to communicate with only one of one side or the other side of the pin 310. In addition, the second flow paths 312 formed at the one side and the other side of the pin 310 may be formed to be spaced a predetermined interval from each other, that is, misaligned with each other, in the axial direction of the motor.

The shapes of the first flow path 311 and the second flow path 312 are not limited to those illustrated in the drawing and can be easily changed and applied by a user according to the physical properties of lubricant or positions of parts of the reducer (position to which lubricant will be supplied). One end of the first flow path 311 may be disposed to face the outlet of the forced lubrication reduction flow path 220, and thus the first flow path 311 may receive and store lubricant from the forced lubrication reduction flow path 220, and the second flow path 312 may receive the stored lubricant from the first flow path 311 and transfer the lubricant to each part of the reducer.

The first flow path 311 may have a groove shape in which one end that comes into contact with one surface of the carrier 100 is open and the other end is closed. Accordingly, the lubricant received from the forced lubrication reduction flow path 220 can be easily accommodated and stored therein. In addition, the first flow path 311 may further have an open groove 313 that has a larger flow cross-sectional area than the first flow path 311 and is formed at one end thereof. The open groove 313 may serve as a funnel and more smoothly receive the lubricant from the forced lubrication reduction flow path 220 through the large open area. In addition, the pin 310 may have a transfer hole 314 that communicates with the first flow path 311, the open groove 313, the oil spreader 320, and the transfer flow path 110. Lubricant may be transferred from the oil spreader 320 to the inside of the pin 310 through the transfer hole 314.

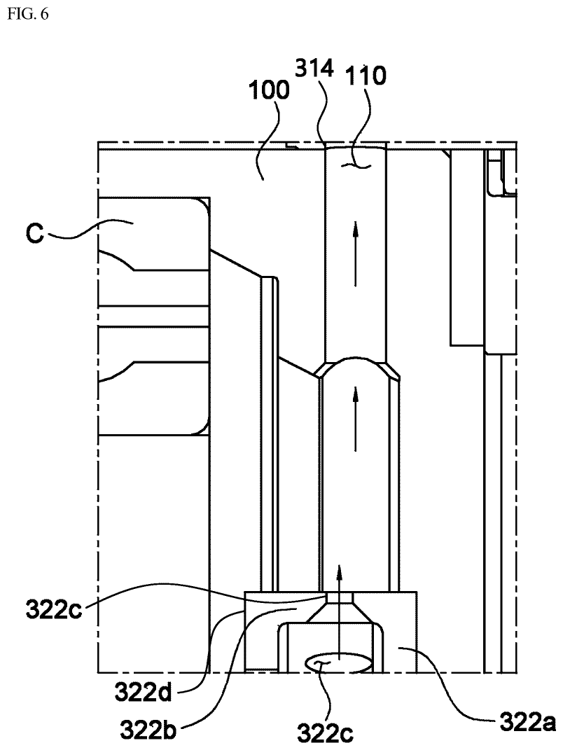

In addition, as illustrated in FIG. 6, the carrier 100 may include the transfer flow path 110 of which one end communicates with the first flow path 311 and which is formed to extend in the radial direction of the motor. As an example, the carrier 100 may have one end that communicates with the transfer hole 314 and the open groove 313. As described above, the transfer flow path 110 may receive lubricant from the spray holes 322c of the oil spreader 320. The lubricant preferably flows due to the centrifugal force when the motor rotates. More specifically, lubricant may be transferred sequentially through the spray hole 322c of the oil spreader 320, the transfer flow path 110, the transfer hole 314, and the first flow path 311 by a centrifugal force. Accordingly, the lubricant sprayed from the forced lubrication reduction flow path 220 may be transferred to the internal parts of the reducer by only the centrifugal force and wind power when the motor rotates without separate pumping.

According to the lubricant supply system of the present disclosure according to the above configuration, by including the flow path along which lubricant is supplied to the shaft, the oil spreader coupled to the shaft, and the carrier that receives oil dispersed from the oil spreader and inserting the pin that stores and supplies lubricant into the carrier, it is possible to minimize forced lubrication compared to conventional ones and allow oil to be smoothly supplied to a needle bearing and a carrier bearing even during high-speed rotation using a centrifugal force and wind power generated naturally by an on-axis rotors.

The technical spirit of the present disclosure should not be construed as limited to the above-described embodiments. Not only the scope of applications is diverse, but also various modifications may be made by those skilled in the art without departing from the gist of the present disclosure as claimed in the claims. Therefore, these improvements and changes fall within the scope of the present disclosure as long as they are obvious to those skilled in the art.

What is claimed is:

1. A lubricant supply system mounted on a motor, comprising:
a carrier which has an insertion hole formed at a central portion thereof and in which a carrier bearing of the motor is inserted into the insertion hole;
an oil flow path inserted into a housing of the motor; and
an oil dispersion part that is coupled to the carrier and a shaft of the motor and disperses lubricant,
wherein the oil flow path is formed to have at least one outlet facing the shaft side so that lubricant is sprayed to the shaft of the motor.

2. The lubricant supply system of claim 1, wherein the oil flow path includes:
a main flow path connected to a pump that supplies lubricant and formed to extend in a radial direction of the motor; and
a forced lubrication reduction flow path formed to extend from the main flow path toward the shaft of the motor.

3. The lubricant supply system of claim 2, wherein the oil dispersion part includes an oil spreader that is inserted between the insertion hole and the shaft of the motor and disperses lubricant received from the forced lubrication reduction flow path in the radial direction of the motor.

4. The lubricant supply system of claim 3, wherein the oil spreader includes:
a fixed part in which a coupling hole inserted into the shaft of the motor is formed; and
a spray part that is formed to extend in the radial direction from the fixed part and stores and sprays lubricant.

5. The lubricant supply system of claim 4, wherein the spray part includes:
a first extension that has one end connected to an end of the fixed part and is formed to extend in the radial direction of the motor;
a second extension formed to extend from the first extension in the axial direction of the motor; and
a third extension formed to extend from the second extension in the radial direction of the motor.

6. The lubricant supply system of claim 5, wherein the second extension has two or more spray holes formed in a circumferential direction of the oil spreader.

7. The lubricant supply system of claim 3, wherein the oil dispersion part includes a pin which is inserted into the carrier in an axial direction of the motor and in which a flow path in which lubricant is stored is formed to extend in the axial direction of the motor.

8. The lubricant supply system of claim 7, wherein the pin includes:
a first flow path in which lubricant is stored and which is formed to extend in the axial direction of the motor; and
a second flow path formed in a direction perpendicular to the first flow path and formed to pass through the pin.

9. The lubricant supply system of claim 8, wherein the first flow path includes an open groove of which one end that comes into contact with one surface of the carrier is open and the other end is closed and which has a larger flow cross-sectional area than the first flow path at one end thereof.

10. The lubricant supply system of claim 8, wherein the carrier includes a transfer flow path of which one end communicates with the first flow path and which is formed to extend in the radial direction of the motor.
